(19) United States
(12) Patent Application Publication
(10) Pub. No.: US 2014/0032665 A1
(43) Pub. Date: Jan. 30, 2014

(54) ACTIVITY-BASED CONTENT SELECTION

(71) Applicant: GOOGLE INC., Mountain View, CA (US)

(72) Inventors: Aitan Weinberg, Brooklyn, NY (US); Di-Fa Chang, Cupertino, CA (US); Oren Eli Zamir, Los Altos, CA (US); Qing Xu, San Jose, CA (US); Anusha Sriraman, Sunnyvale, CA (US); Eu-Jin Goh, Palo Alto, CA (US); Alok Aggarwal, Foster City, CA (US)

(73) Assignee: Google Inc., Mountain View, CA (US)

(21) Appl. No.: 13/853,775

(22) Filed: Mar. 29, 2013

(30) Foreign Application Priority Data
Jul. 26, 2012 (IL) 221156

(51) Int. Cl. H04L 29/08

(52) U.S. Cl. CPC H04L 67/22
USPC 709/204

(57) ABSTRACT

A computer-implemented method includes receiving a computer-implemented model adapted to process past online behavior of a user identifier of a networked computing device and determine an online activity type associated with the user identifier based on the past online behavior of the user identifier. The method also includes receiving data representing past online behavior of the user identifier of the networked computing device. The method also includes processing the model and the data representing past online behavior of the user identifier of the network computing device to determine an online activity type associated with the user identifier. The method also includes and providing information about the online activity type to a content selection server to facilitate selection of content to be presented to the user identifier.

The present disclosure claims foreign priority to Israeli Patent Application No. 221,156, entitled “METHOD AND COMPUTER PROGRAM PRODUCT FOR ACTIVITY-BASED CONTENT SELECTION,” and filed Jul. 26, 2012, the entirety of which is hereby incorporated by reference.

### BACKGROUND

The present disclosure relates generally to selecting content to provide online, such as advertisements. The present disclosure more specifically relates to generating information to be used in selecting content to be delivered.

Content providers, such as advertisers, deliver content impressions to a group of user identifiers associated with certain common properties. For example, content may be delivered to user identifiers associated with certain locations, user identifiers associated with interests in certain categories of content, user identifiers associated with specific ages, genders, etc. When a user identifier is engaged in online activity, e.g., while using a web browser to access content on the internet, the user identifier may be presented with content that has been selected from among different available content.

### SUMMARY

Implementations of the systems and methods for providing information about an online activity type are described herein. These implementations may relate to content-delivery campaigns based on information relating to a user identifier. In some implementations, a user can control a plurality of properties associated with their attribute data or the attribute data associated with an anonymous user device or user identifier (e.g., a cookie). For example, the user may view and/or edit their attribute data. A user may select to opt in or opt out of having their attribute data collected and/or transmitted. A user may also control these properties for some or all web sites. For example, the user may specify that a certain web site cannot store any attribute information associated with the user. In another example, the user may restrict an entity from determining or storing certain types of attribute information. In some implementations, content activity attribute may be completely anonymous (e.g., an entity cannot associate attribute data with a unique user identifier).

One implementation is a method of providing information about an online activity type of a user to a content selection server. The method includes receiving, in a computer system, a computer-implemented model adapted to process past online behavior of a user identifier of a networked computing device and determine an online activity type associated with the user identifier based on the past online behavior of the user identifier. The method also includes receiving, by a computer system, data representing past online behavior of the user identifier of the networked computing device. The method also includes processing, by the computer system, data representing past online behavior of the user identifier of the network computing device using a model, the model being configured to process past online behavior of the user identifier of the networked computing device and determine an online activity type associated with the user identifier based on the past online behavior of the user identifier. The method also includes selecting, by the computer system, content to be presented to the user identifier based on the online activity type associated with the user identifier.

This and other implementations can each optionally include one or more of the following features. The method also may include receiving selected content from a content selection server and presenting the selected content to the user as display content in a web browser. The computer-implemented model may be generated using a learning algorithm, which may include a support vector machine. The learning algorithm also may include a logistic regression. The online activity type may indicate that the user is involved in one or more of a shopping activity, a browsing activity, a game-playing activity, an idling activity, a recreational activity, and a professional activity. The past online behavior of the user may include one or more of email activity, search query activity, and viewing a web page.

Another implementation is a computer-readable storage medium encoded with instructions that, when executed on a processing unit, perform a method. The method includes receiving, in a computer system, a computer-implemented model adapted to process past online behavior of a user of a networked computing device and determine an online activity type associated with the user based on the past online behavior of the user. The method also includes receiving, in the computer system, data representing past online behavior of the user of the networked computing device. The method also includes processing, in the computer system, the model and the data representing past online behavior of the user of the network computing device, to determine an online activity type associated with the user. The method also includes providing information about the online activity type to a content selection server to facilitate selection of content to be presented to the user.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system in accordance with a described implementation;

FIG. 2 is a diagram of a web page in accordance with a described implementation;

FIGS. 3 and 4 are flow diagrams of processes in accordance with described implementations.

### DETAILED DESCRIPTION

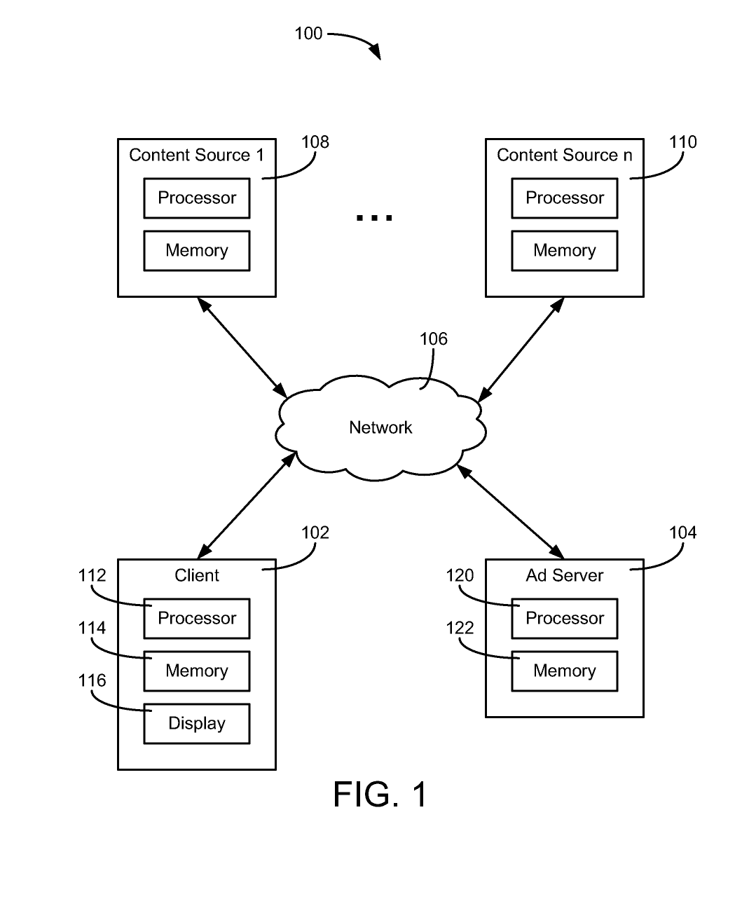

Referring to FIG. 1, a block diagram of a computer system 100 in accordance with a described implementation is shown. System 100 includes a client 102 which communicates with other computing devices via a network 106 and which is associated with at least one user identifier. For example, client 102 may communicate with one or more content sources ranging from a first content source 108 up to an nth content source 110. Content sources 108, 110 may provide webpages and/or media content (e.g., audio, video, and other forms of digital content) to client 102. System 100 may also include a server 104, which may perform analytics on the webpages provided by content sources 1-n and also may provide content to be included in the webpages over network 106. The content to be included in the webpages may include advertisements that are configured to be displayed to a user identifier of client 102 in a web browser that is displaying one or more of the webpages.

Network 106 may be any form of computer network that relays information between client 102, server 104, and content sources 108, 110. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CATS cable, etc.) to other computing devices in network 106.

Client 102 may be any number of different user electronic devices configured to communicate via network 106 (e.g., a laptop computer, a desktop computer, a tablet computer, a smartphone, a digital video recorder, a set-top box for a television, a video game console, etc.). Client 102 is shown to include a processor 112 and a memory 114, i.e., a processing circuit. Memory 114 stores machine instructions that, when executed by processor 112, cause processor 112 to perform one or more of the operations described herein. Processor 112 may include a microprocessor, application-specific integrated circuit (ASIC), field-programmable gate array (FPGA), etc., or combinations thereof. Memory 114 may include, but is not limited to, electronic, optical, magnetic, or any other storage or transmission device capable of providing processor 112 with program instructions. Memory 114 may further include a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which processor 112 can read instructions. The instructions may include code from any suitable computer-programming language such as, but not limited to, C, C++, C#, Java, JavaScript, Perl, Python and Visual Basic.

Client 102 may also include one or more user interface devices. In general, a user interface device refers to any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to a housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which visually displays webpages using webpage data received from content sources 108, 110 and/or from server 104.

Content sources 108, 110 are electronic devices connected to network 106 and provide media content to client 102. For example, content sources 108, 110 may be computer servers (e.g., FTP servers, file sharing servers, web servers, etc.) or other devices that include a processing circuit. Media content may include, but is not limited to, webpage data, a movie, a sound file, pictures, and other forms of data, including advertisement data, such as may be displayable as part of a webpage. Similarly, server 104 may include a processing circuit including a processor 120 and a memory 122. In some implementations, server 104 may include several computing devices (e.g., a data center, a network of servers, etc.). In such a case, the various devices of server 104 may be in electronic communication, thereby also forming a processing circuit (e.g., processor 120 includes the collective processors of the devices and memory 122 includes the collective memories of the devices).

Server 104 may provide content to client 102 via network 106. For example, content source 108 may provide a webpage to client 102, in response to receiving a request for a webpage from client 102. In some implementations, content from server 104 may be provided to client 102 indirectly. For example, content source 108 may receive content from server 104 and use the content as part of the webpage data provided to client 102. In other implementations, content from server 104 may be provided to client 102 directly. The content also may include one or more advertisements selected for delivery as described in detail below. For example, content source 108 may provide webpage data to client 102 that includes a command to retrieve content from server 104. On receipt of the webpage data, client 102 may retrieve content from server 104 based on the command and display the content when the webpage is rendered on display 116. The content also may include one or more advertisements selected for delivery as described in detail below.

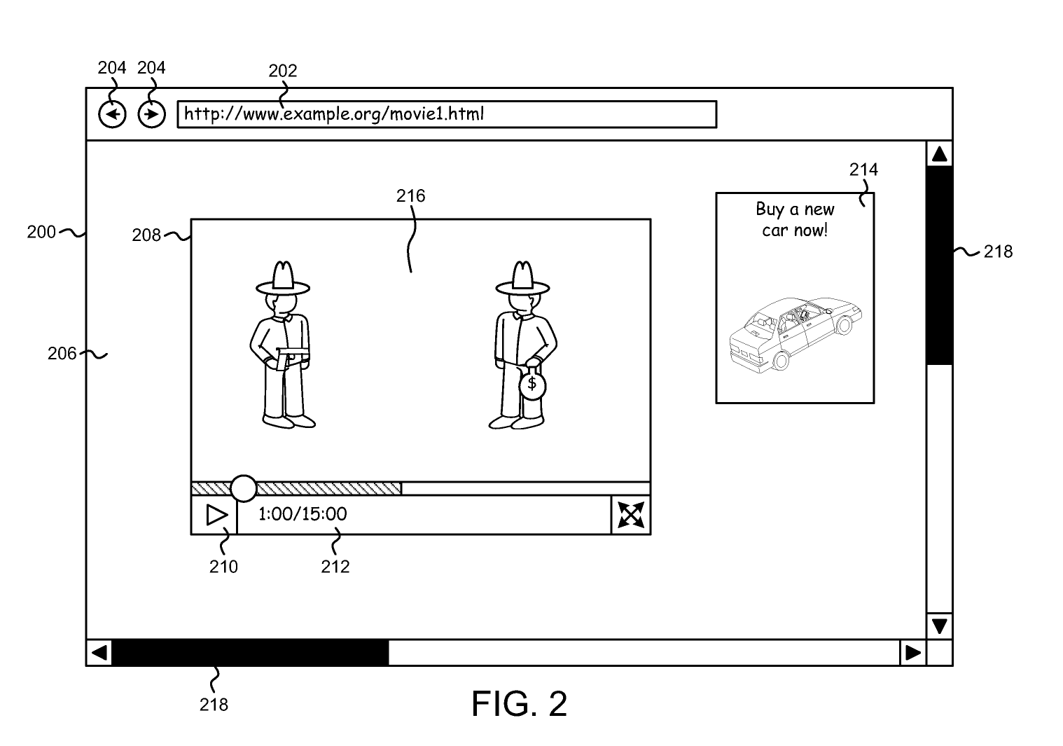

As shown in FIG. 2, the one or more processors in communication with display 200 may execute a web browser application (e.g., display 200 is part of a client device). The web browser application operates by receiving input of a uniform resource locator (URL) into a field 202, such as a web address, from an input device (e.g., a pointing device, a keyboard, a touchscreen, or another form of input device). In response, one or more processors executing the web browser may request data from a content source corresponding to the URL via a network (e.g., the Internet, an intranet, or the like). The content source may then provide webpage data and/or other data to the client device, which causes visual indicia to be displayed by display 200.

In general, webpage data may include text, hyperlinks, layout information, and other data that is used to provide the framework for the visual layout of displayed webpage 206. In some implementations, webpage data may be one or more files of webpage code written in a markup language, such as the hypertext markup language (HTML), extensible HTML (XHTML), extensible markup language (XML), or any other markup language. For example, the webpage data in FIG. 2 may include a file, “moviel.html” provided by the website, “www.example.org.” The webpage data may include data that specifies where indicia appear on webpage 206, such as movie 216 or other visual objects. In some implementations, the webpage data may also include additional URL information used by the client device to retrieve additional indicia displayed on webpage 206. For example, the file, “moviel.html,” may also include one or more tags used to retrieve a display advertisement 214 from a remote location (e.g., the server 104, the content source that provides webpage 206, etc.) and to display the display advertisement 214 on display 200.

When a user identifier is engaged in online activity, e.g., while using a web browser to access content on the internet, as shown on display 200, the user identifier may be presented with content including advertisements, such as display advertisement 214, that may have been selected from among different available advertisements. According to various implementations of the present invention, content also may be selected on the basis of innovative principles. Specifically, content selection may incorporate information about an activity type of the user identifier. When a user identifier is active online, there are various activities the user identifier may be performing.

For example, the user identifier may be shopping. When a user identifier is actively involved in the act of shopping, direct response advertisements are one type of content that may be expected to have a good rate of conversion. When a visitor to a website navigates to a goal webpage or completes some other predefined interaction or task, such as clicking on an interactive display advertisement this may be referred to as a “conversion.” A direct response advertisement delivered to an online user identifier that is associated with currently active shopping activity would thus be expected to be an efficient choice of content because the content is providing something that the user identifier is looking for already: goods and/or services for sale. Additional factors are also significant in selecting content to be delivered, such as demographic information, known interests associated with the user identifier, and the like. If a user identifier is shopping specifically for shoes, for example, direct-response shoe advertisements may be more appropriate and likely to result in a conversion than either direct-response advertisements for vacation cruises or brand advertisements for shoes. Consideration of activity type information about the online user identifier in combination with these other factors can thus facilitate selection of content that is expected to have better conversion rates than content that would be selected without knowledge of the user identifier's current activity type.

In other cases, a user identifier will not be presently engaged in the act of shopping. In such cases, content that is selected without taking into consideration the current activity type of the user identifier will tend to be less effective. For example, demographic data and user identifier interest data may indicate that a user identifier is likely to be associated with an interest in basketball shoes. If that user identifier is currently engaged in a non-shopping activity, such as online gaming, the user identifier will be less receptive to direct-response advertisements for basketball shoes than at a time when the user identifier is actively shopping. But furthermore, there may be other content that is more appropriate and likely to be effective. The user identifier may be more likely at that time to respond to an advertisement for a new online gaming service, for example, or even may be more likely to be receptive to a brand advertisement for a popular console video game. Other, non game-related content selection strategies also may use the knowledge that the user identifier is presently engaged in the act of online gaming. Content providers may determine that someone who is presently playing online games may be especially likely to respond to an advertisement for fast food, such as a pizza delivery service. Since the user is associated with currently being engrossed in the game and not wanting to step away for very long, it may also be associated with the inconvenience of having to prepare food from scratch or to travel to a restaurant, such that the idea of having food delivered may be a welcome suggestion—whereas a direct response advertisement for shoes would simply be a distraction.

In other cases, a user identifier may be associated with working or otherwise being engaged in an activity having to do with practicing a profession associated with the user identifier. The user identifier may then be less likely to be interested in content relating to personal interests and consumer shopping. The user may be more likely, however, to be associated with interest in content selected for a professional capacity associated with the user identifier. An information technology officer who is actively working, for example, may be more likely to be interested in brand impressions for enterprise software solutions that could potentially be of use to the officer's company than direct response advertisements for consumer products. Similarly, advertisements for computer hardware vendors may be of particular interest. As another example, a corporate executive who, while working, receives an advertisement for business travel services may be more receptive to the content because the executive may have several upcoming business trips to plan, but the executive may not have time to respond to an advertisement for vacation travel. Such content might be better presented at a time when the executive is off the clock.

In other cases, a user identifier may be engaged in the act of consuming information about current events, such as by reading an online news service or watching news reporting online. One example of content that may be of particular interest to the user identifier at such a time is an advertisement for a subscription to a newspaper, magazine or other periodical, business news website, etc. Similarly, advertisements for popular fiction novels may not be as closely aligned to the user identifier's current activity as advertisements for news services, but such book advertisements may be of more interest to the user identifier than advertisements for car insurance, for example. A user identifier that is associated with currently reading news on either a free website or a site for which the user identifier already is a subscriber may not always be looking for new subscription services for news, but may be associated with being an avid reader, and being currently involved in reading, and thus may be more inclined to seek out pleasure reading by following an advertisement relating to popular fiction.

In other cases, a user identifier may be engaged in a recreational activity. For example, a user identifier may be associated with checking sports scores, posting to a social-media website, or playing an online game. The latter case is an example of how more than one activity type may apply to a user identifier at time, in that an activity type “game playing” also would be accurate. When a user identifier is engaged in a recreational activity, one example of content that may be less effective is content that relates to the work associated with the user identifier, as some people may not enjoy being reminded of work while engaged in recreational activities. An advertisement that relates to sports memorabilia, for example, might be better received instead.

In other cases, a user identifier may be engaged in a browsing activity. For example, a user identifier may be following a series of links between web pages, such as between pages of a comprehensive online encyclopedia, without entering any information other than mouse clicks. In some cases, other activity types may apply at the same time, such as “working,” “recreational,” etc. A user identifier that is browsing may be more open to a variety of content types, as the user identifier may not be following a definite goal other than to view interesting content.

In other cases, a user identifier may not clearly be engaged in any online activity. The user identifier may thus be idle. Such a realization also may in some cases be leveraged in selecting content. In some cases, a user identifier may, for example, be associated with being bored and not have anything to do at the moment. It may be that the user identifier is idle because someone is staring out of the window while sitting in front of the computer, instead of being engaged in any particular online activity. Such a user identifier may be receptive to content relating to diversions such as online games, horoscopes and the like. A user identifier also may be idling because someone is suffering from writer's block, falling asleep at work, or otherwise having difficulty concentrating. Such a user identifier may respond to advertisements for energy drinks and other stimulants. Another content selection strategy could be to try to entice such a user identifier with the previously mentioned diversions, in the hopes that the user identifier temporarily abandons the user identifier's current task in lieu of something more enjoyable.

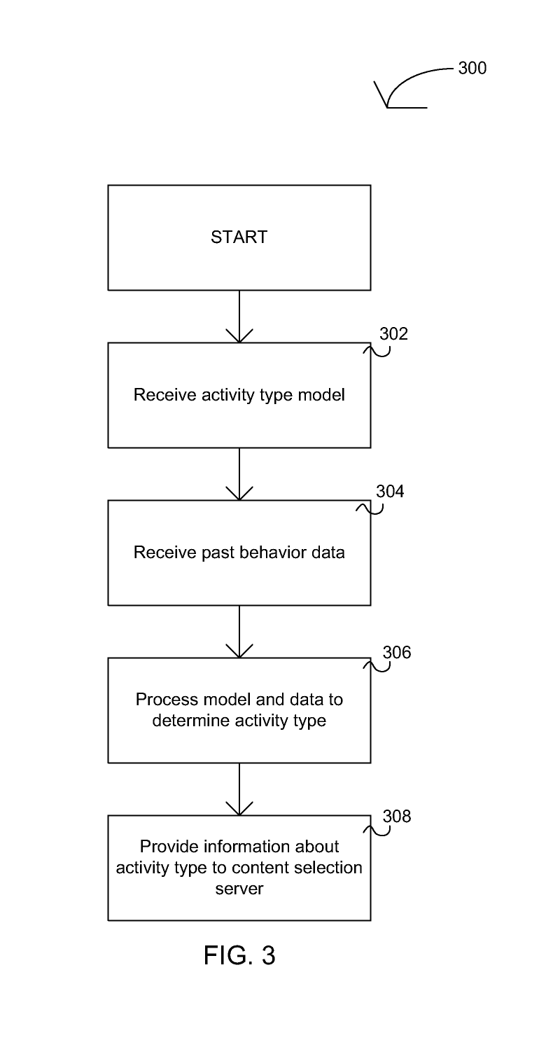

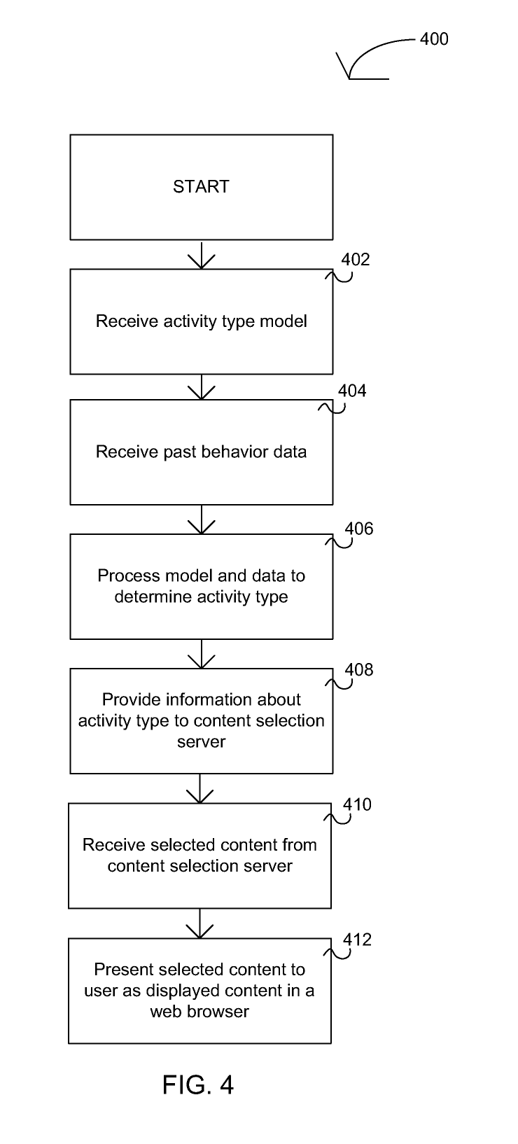

A process 300 for generating information to be used in selecting content to be presented to a user identifier is now described with reference to FIG. 3. The process 300 begins at block 302 where an activity type model is received. The model may be received at, e.g., a server such as server 104 in FIG. 1. The activity type model is a model that can take an input of past behavior data for a user identifier and provide an output of an activity type that describes the type of activity in which the user identifier is likely engaged at the moment. According to exemplary implementations, user software may be configured to allow a user identifier to control what types of information about past behavior may or may not be accessed for analysis. The model thus can implement an inference algorithm that infers the user identifier's activity type based on the user identifier's online behavioral history. The user identifier's activity type is modeled as a function of past online behavior. For example, past page views may be evaluated to determine the user identifier's activity type. Information relating to past page views may include keyword data representing keywords that are extracted from and describe the previously viewed pages as well as keywords that are included in the previously viewed pages for search and indexing purposes. The information relating to past page views also may include category information relating to the previously viewed pages. For example, an electronic commerce website may be classified as belonging to a category such as “shopping,” while a newspaper's website may be classified as belonging to a category such as “news.” Web pages may belong to more than one category, as well. Determination of a category into which a web page falls can be performed in various ways, such as by maintaining locally or accessing a remote database listing categories of popular websites. Categories also may be determined according to automatic analysis of the content of the websites, including analysis of textual content of the website as well as of keywords provided for the website.

Another type of information that may be evaluated in determining a user identifier's activity type is search keywords. If a user identifier's recent online behavior includes one or more text searches, the keywords used in the search may be analyzed. For example, if a user identifier executed a search for “designer brand jeans,” the text of the search query may be analyzed to determine that the user identifier is likely engaged in actively shopping. On the other hand, if a user identifier executed a search for “fire downtown today,” the query may be analyzed to determine that the user identifier likely is not shopping, but may be looking for news stories. Alternatively, the user identifier may be looking for traffic information, due to a desire to avoid the fire during a commute to work. Accordingly, one or more possible activity types may be returned. In some cases, relative likelihood data may be provided, indicating a likelihood that each of the identified activity types is the correct activity type.

Another type of recent online behavior that may be analyzed to determine a user identifier's activity type is email activity. The fact that a user identifier is associated with currently composing, reading, and/or sending email is in and of itself an indicator of the user identifier's activity type. Namely, the user identifier may still be reading and writing email generally. Furthermore, the text contained within the emails that are being viewed, sent, and/or received may in some cases be analyzed to determine a user identifier's likely activity type. For example, if a user identifier has been writing emails discussing business matters such as employee recruiting, meeting schedules, profit projections, etc., the user identifier's activity type may be “working.” On the other hand, if a user identifier has been sending and receiving emails regarding schedules of days off from work, descriptions of various tourist attractions and vacation leisure activities, the user identifier may be associated with planning a trip.

The activity type model can be developed using a learning algorithm. Exemplary types of learning algorithms that may be employed include support vector machines and logistic regressions. The learning algorithm is provided training data, in which data from exemplary historical user identifier behavior is provided that has been associated with one or more user identifier activity types. By analyzing the relationships between the past user identifier behavior data and the associated activity types, the learning algorithm can be trained to recognize expected activity types associated with certain types of past user identifier behavior data.

Training data sets to be provided to the learning algorithm may be generated manually or automatically. Manual generation of a training data set may include explicitly associating one or more activity types with a particular example of past user identifier behavior. For example, an analyst may receive one or more exemplary internet browsing histories, search queries, etc. and then associate one or more activity types with the exemplary data according to the analyst's understanding of what a user identifier likely was doing to create such an online history. Alternatively, the analyst may be given one or more activity types and may then perform internet searches, visit web sites, etc. to generate examples of behavior according to the activity type in question. In other implementations, rules may be defined for classifying training data into activity types. For example, a rule could be defined that classifies user identifiers visiting websites of major retailers and internet commerce websites as “shopping.” Another rule could be defined that classifies user identifiers visiting online gaming sites as “game playing.” These rules are then applied to historical data to classify as many user identifiers as possible into various types of activities, thus forming the training data. For an activity type, user identifiers who are classified as performing that activity serve as positive training samples and the rest of the population in the training data set serve as negative training samples. The learned model is then applied to the whole population and categorizes all user identifiers' activity types.

With further reference to FIG. 3, the activity type model may be received 302 from a third-party source, or also may be generated at server 104 of FIG. 1. Past user identifier behavior data is also received at block 304. The past user identifier behavior data may be any type of data that was accounted for in the generation of the model, such that the model accepts the data as input. The past user identifier behavior data may be received via network 106 of FIG. 1 from client 102, where a user identifier is using the client to access network 106 and more particularly, to receive content from content sources 108 through 110. The past user identifier behavior data may thus include information relating to particular content sources that are accessed and particular content that is provided by those content sources. The process continues at block 306 where the model and data are processed to determine an activity type. The processing may occur at server 104 of FIG. 1, or alternatively may be performed at a remote server that is accessible via network 106 of FIG. 1.

The process continues at block 308 where information about the user identifier's activity type is provided to a content selection server. According to some implementations, the content selection server may be located locally with respect to server 104, while in other implementations the content selection server may be located remote from server 104 and accessible via network 106. The information about the user identifier's activity type may include a single activity type. The information also may include more than one activity type. The information also may include probability information indicating a likelihood that the user identifier is currently engaged in the particular activity. For example, the activity type model may provide a result that indicates an equal probability that a user identifier is currently shopping or that the user identifier is currently working. The content selection server also may be provided any further information that may be used in selection of content, such as demographic information of the user identifier, information regarding the user identifier's known interests, a geographic location of the user identifier, etc.

A process 400 for generating information to be used in selecting content to be presented to a user identifier is now described with reference to FIG. 3. The process 400 begins at block 402 where an activity type model is received. The process continues at block 404 where past behavior data is received. The process continues at block 406 where the activity type model and past behavior data are processed to determine a user identifier activity type. The process continues at block 408 where information about the user identifier activity type is provided to a content selection server. The process continues at block 410 where selected content is received from the content selection server. The content selection server can use various types of information is determining the content to select, including the activity type information as well as demographic information, geographic information, user identifier interest information, and other types of information. In some implementations, the content selection server may provide more than one item of content, of which one, some, or all may eventually be presented to the user identifier. The process continues at block 412 where the selected content is presented to the user identifier as a display advertisement in a web browser. In other implementations content may be presented in other forms, such as audio advertisements, advertisements that are presented in other software applications, such as stand-alone email applications, etc.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs embodied in a tangible medium, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus or processing circuit on data stored on one or more computer-readable storage devices or received from other sources.

The term “client or “server” includes all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors or processing circuits executing one or more computer programs to perform actions by operating on input data and generating output. The processes and logic flows can also be performed by, and apparatus can also be implemented as, special purpose logic circuitry, e.g., an FPGA or an ASIC.

Processors or processing circuits suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, the method comprising:
receiving, in a computer system, a computer-implemented model adapted to process past online behavior of a user identifier of a networked computing device and determine an online activity type associated with the user identifier based on the past online behavior of the user identifier;
receiving, by a computer system, data representing past online behavior of the user identifier of the networked computing device;
processing, by the computer system, data representing past online behavior of the user identifier of the network computing device using a model, the model being configured to process past online behavior of the user identifier of the networked computing device and determine an online activity type associated with the user identifier based on the past online behavior of the user identifier; and
selecting, by the computer system, content to be presented to the user identifier based on the online activity type associated with the user identifier.

2. The method of claim 1, wherein the online activity type indicates that the user identifier is involved in a shopping activity, wherein the shopping activity includes at least one of:
requesting information about a product; and
receiving information about a product in response to an inquiry by the user identifier.

3. The method of claim 1, wherein the online activity type indicates that the user identifier is involved in a game-playing activity, wherein the game-playing activity includes communicating with a web page associated with providing access to an online game.

4. The method of claim 1, wherein the online activity type indicates that the user identifier is involved in an idling activity, wherein the idling activity includes taking no action to request information online or send information online over a predetermined period of time.

5. The method of claim 1, wherein the online activity type indicates that the user identifier is involved in a recreational activity, wherein the recreational activity includes communicating with a web page associated with at least one of sports, social-media, and online games.

6. The method of claim 1, wherein the online activity type indicates that the user identifier is involved in a professional activity, where the professional activity includes at least one of:
requesting information relating to practicing a profession associated with the user identifier; and
receiving information to practicing a profession associated with the user identifier in response to an inquiry by the user identifier.

7. The method of claim 1, wherein the data representing past online behavior of the user identifier includes data representing email activity, the email activity including at least one of composing, reading and sending an email.

8. The method of claim 1, wherein the data representing past online behavior of the user identifier includes data representing search query activity, the search query activity including at least one of submitting a text search and receiving information in response to a text search.

9. The method of claim 1, wherein the data representing past online behavior of the user identifier includes data representing web page viewing activity, the web page viewing activity including viewing a web page, the web page including at least one of a keyword and textual content.

10. The method of claim 1, further comprising:
receiving selected content from a content selection server; and
presenting the selected content to the user as display content in a web browser.

11. The method of claim 1, wherein the computer-implemented model is generated using a learning algorithm.

12. The method of claim 11, wherein the learning algorithm includes a support vector machine.

13. The method of claim 11, wherein the learning algorithm includes a logistic regression.

14. A computer-readable storage medium encoded with instructions that, when executed on a processing unit, perform a method, the method comprising:
receiving, in a computer system, a computer-implemented model adapted to process past online behavior of a user identifier of a networked computing device and determine an online activity type associated with the user identifier based on the past online behavior of the user identifier;
receiving, in the computer system, data representing past online behavior of the user identifier of the networked computing device;
processing, in the computer system, the model and the data representing past online behavior of the user identifier of the network computing device, to determine an online activity type associated with the user identifier; and
providing information about the online activity type to a content selection server to facilitate selection of a content to be presented to the user identifier.

15. The computer-readable storage medium of claim 14, wherein method performed by the processing unit further includes:
receiving selected content from the content selection server; and
presenting the selected content to the user identifier as display content in a web browser.

16. The computer-readable storage medium of claim 14, wherein the computer-implemented model is generated using a learning algorithm.

17. The computer-readable storage medium of claim 16, wherein the learning algorithm includes a support vector machine.

18. The computer-readable storage medium of claim 16, wherein the learning algorithm includes a logistic regression.

19. The computer-readable storage medium of claim 14, wherein the data representing past online behavior of the user identifier includes data representing email activity, the email activity including at least one of composing, reading and sending an email.

20. The computer-readable storage medium of claim 14, wherein the data representing past online behavior of the user identifier includes data representing search query activity, the search query activity including at least one of submitting a text search and receiving information in response to a text search.
